(19) United States
(12) Patent Application Publication
(10) Pub. No.: US 2015/0318600 A1
(43) Pub. Date: Nov. 5, 2015

(54) Radio Frequency Power Combiner

(71) Applicant: SIEMENS RESEARCH CENTER LIMITED LIABILITY COMPANY, Moscow (RU)

(72) Inventors: Alexey GUDOVICH, Moscow (RU); Manuel HEILMANN, Hasselroth (DE); Ulrich RATZINGER, Weiterstadt (DE); Yulia VASILEVA, Moscow area (RU)

(73) Assignee: Siemens Research Center Limited Liability Company, Moscow (RU)

(21) Appl. No.: 14/762,178

(22) PCT Filed: Jan. 28, 2014
(86) PCT No.: PCT/RU2014/000067

§ 371 Date: Jul. 20, 2015

(30) Foreign Application Priority Data
Feb. 1, 2013 (RU) 2013104458

(51) Int. Cl. H01P 5/12; H02J 5/00; H01F 38/14

(52) U.S. Cl. CPC H01P 5/12; H01F 38/14; H02J 5/005; H01F 2038/143

(57) ABSTRACT

High-power microwave generators usable in designing circuits of power combiners/dividers, wherein a device for combining radio frequency power includes a cavity, for example, having a rectangular shape, a central cylindrical conductor with a larger radius middle portion, inductive coupling elements for inputting RF power from sources to the cavity, a movable output element secured on the central cylindrical conductor for outputting the combined power, where the device offers high frequency and phase stability, and has a compact design.

### CROSS-REFERENCE TO RELATED APPLICATIONS

This is a U.S. national stage of application No. PCT/RU2014/000067 filed 28 Jan. 2014. Priority is claimed on Russian Application No. 2013 104 458 filed 1 Feb. 2013, the content of which is incorporated herein by reference in its entirety.

### BACKGROUND OF THE INVENTION

1. Field of the Invention

The invention relates to high-power microwave generators that are used to design circuits of power combiners/dividers.

2. Description of the Related Art

Powerful microwave generators are currently constructed by one of two basic schemes: as a single high power amplifier or based on combining power from several individual sources. The present application considers the second scheme of generators.

A variety of schemes of power combiners/dividers are known in the art. Most conventional power combiners operate on two principles of combining/dividing power. A first principle relies on the use of different transmission lines implemented in coaxial cables, strip lines and baluns for transition between transmission lines of different type. Examples of such power combiners based on the Wilkinson scheme are disclosed in U.S. Pat. Nos. 5,767,755 and 5,334,957 and provide for the use of a plurality of transmission lines with a plurality of input terminals and an output terminal, and a plurality of RF switches for opening/closing respective connections that provide an RF signal from respective inputs. Multichannel power combiners/dividers based on the Gysel principle, such as those disclosed in U.S. Pat. Nos. 5,164,689 and 5,880,648, comprise a common output/input port, a plurality of input/output ports and a corresponding plurality of first and second transmission lines interconnecting the respective ports, which are implemented on planar substrates by the microstrip technology or with coaxial transmission lines for high power levels. However, these two types of schemes have limitations on the transmitted power levels, which usually do not exceed a few kW.

Another well known principle of combining/dividing power relies on the use of waveguide couplers, which use the principle of joining a set of waveguides in a single waveguide. Here, input and output can be provided on the same type of waveguides (see, e.g., U.S. Pat. No. 6,411,174 or U.S. Pat. No. 5,892,414) or with transformation of the wave type taking into account specific needs of the design, for example, using a coaxial to waveguide transition (see, US 2012/0025928) or rectangular-to circular waveguide transition (see, U.S. Pat. No. 7,432,780). Power combiners of this type can operate at high power levels, but they have limitations on the number of power sources being combined, and have large sizes at low RF bands.

### SUMMARY OF THE INVENTION

It is an object of the present invention to provide a device for combining RF power, which ensures a high stability of frequency and phase, and features a compact size and low cost.

This and other objects and advantages are achieved in accordance with the invention by a device for combining RF power, comprising a cavity, e.g., having a rectangular cross section, with a central (axial) cylindrical conductor, a set of inductive coupling elements for inputting RF power from a plurality of sources into the cavity, and a movable output element for outputting the combined power.

The cavity can be a cylindrical cavity, or can have a polygonal cross section.

The axial cylindrical conductor has a variable diameter, where the middle portion of the axial cylindrical conductor has a larger diameter than its end portions. This allows an increase of the amplitude of magnetic field near the side walls of the cavity.

The length of the cavity is approximately equal to half the wavelength, but may vary because the variation in the radius of the central conductor contributes to the conductivity of the oscillating circuit.

The inductive coupling elements (configured as coupling loops) for inputting RF power are disposed at the maximum of magnetic field amplitude. Such an arrangement provides the best coupling.

The movable output element for outputting the power combined in the cavity volume is configured as a coupling loop and secured on the axial cylindrical conductor.

In a possible embodiment, a method for combining RF power according to the invention comprises:

providing a rectangular cavity with a central conductor disposed along the longitudinal axis of the cavity;

inputting RF power from a plurality of sources to the cavity via respective inductive coupling elements disposed at the maximum of magnetic field amplitude in the cavity;

combining the RF power inputted from the plurality of sources in the cavity, and

outputting the combined RF power from the cavity via a movable coupling element secured on the central conductor.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is illustrated by way of an example illustrated in the accompanying drawings, in which:

FIG. 1 shows schematically an embodiment of a device for combining RF power in accordance with the invention;

FIG. 2a shows the distribution of magnetic field in the cavity with a central conductor having a variable cross-section;

FIG. 2b is a graphical plot illustrating the distribution of the magnetic field amplitude along the length of the cavity;

FIG. 3a shows the distribution of electric field in the cavity with a central conductor having a variable cross-section; and

FIG. 3b is a graphical plot illustrating the distribution of the electric field amplitude along the length of the cavity.

### DETAILED DESCRIPTION OF THE EXEMPLARY EMBODIMENTS

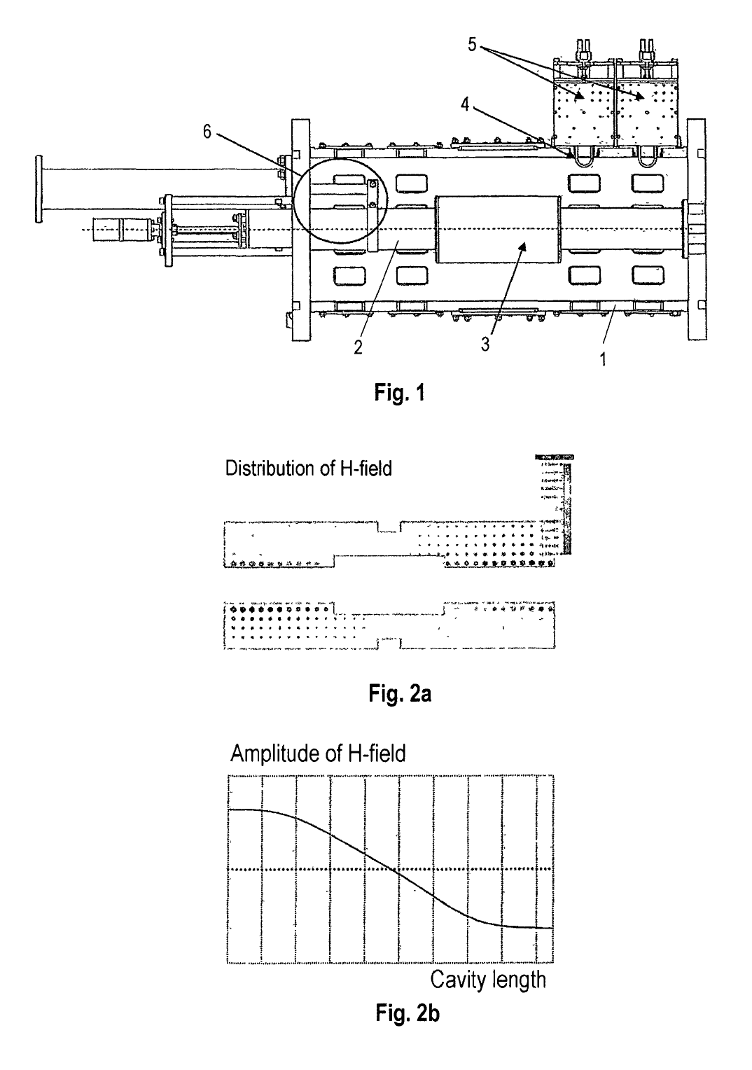

As shown in FIG. 1, the device for combining RF power in accordance with the invention comprises a waveguide 1, a central (axial) cylindrical conductor 2 having a larger radius middle portion 3, elements 4 for inputting RF power from sources 5, configured as inductive coupling loops, and a movable output element 6 for outputting the combined RF power, secured on the central conductor 2. The cavity 1 has a length approximately equal to half the wavelength.

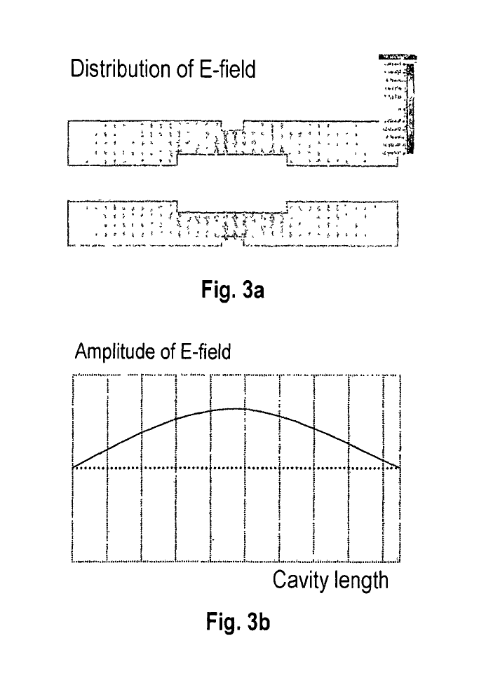

The RF power combining device operates in the following manner. RF power from sources 5 is input via the inductive RF power input elements 4 in the cavity 1. The power input from the plurality of sources 5 is combined in the cavity 1, where the distribution of electric and magnetic fields is set as illustrated in FIGS. 2a and 3b, respectively. FIGS. 2a and 3b show corresponding changes in the amplitudes of magnetic field and electric field along the length of the cavity, respectively.

The combined RF power is output from the cavity 1 via the movable combined RF power output member 6 secured on the central conductor 2.

The present power combiner combines power from up to 64 discrete sources. The number of sources is chosen in accordance with the design tasks to be solved. The inventive methodology offers high stability of frequency and phase, and features a compact size and low cost.

While there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A device for combining radio frequency power, comprising:
a cavity with a central cylindrical conductor;
a plurality of inductive coupling elements for inputting RF power from a plurality of sources to the cavity; and
a movable output element for outputting the combined power, secured on the central cylindrical conductor.

8. The device according to claim 7, wherein said cavity is a cylindrical cavity.

9. The device according to claim 7, wherein said cavity has a polygonal cross section.

10. The device according to claim 7, wherein said cavity has a length equal to half the wavelength.

11. The device according to claim 7, wherein said central cylindrical conductor has a variable diameter; and wherein a middle portion of the central cylindrical conductor has a larger diameter.

12. The device according to claim 11, wherein each of said plurality of inductive coupling elements for inputting RF power is disposed at a maximum of magnetic field amplitude in the cavity.
